(19) United States
(12) Patent Application Publication
(10) Pub. No.: US 2026/0044682 A1
(43) Pub. Date: Feb. 12, 2026

(54) AUTOMATED TECHNICAL DRAFT GENERATION

(71) Applicant: Kofi Aninakwa, New York, NY (US)

(72) Inventor: Kofi Aninakwa, New York, NY (US)

(21) Appl. No.: 19/292,711

(22) Filed: Aug. 6, 2025

Related U.S. Application Data
(60) Provisional application No. 63/679,939, filed on Aug. 6, 2024.

(51) Int. Cl. G06F 40/40

(52) U.S. Cl. CPC G06F 40/40

(57) ABSTRACT

Automated drafting including receiving custom template material with static text and prompts, evaluating the prompts using an LLM to generate context-aware output based on input information material, automatically generating a draft based at least on the static text of the custom template material by preserving the static text and replacing the prompts with the generated output in a context aware manner. Additional context aware instructions are provided to provide information on relevancy of inputs and a manner of generating outputs.

### CROSS-REFERENCE TO RELATED APPLICATIONS

The This patent application claims the benefit of and priority to U.S. Provisional Patent Application Ser. No. 63/679,939, filed on Aug. 6, 2024, which is herein incorporated by reference for all purposes.

### TECHNICAL FIELD

The present disclosure generally relates to automated drafting systems, and more particularly to methods and systems for generating technical draft documents using large language models (LLM), input information material related to the draft, and input template material that dictate the style, format, and executable instructions for the draft.

### BACKGROUND

Various types of software aid in generating drafts across different domains. Some systems that aid in the generations include word processing applications and content generating tools.

The preparation of documents such as engineering specifications, technical reports, and research disclosures requires careful articulation of domain-specific information in a structured, coherent, and often standardized format. Traditionally, this process is labor-intensive, requiring skilled professionals to translate disclosures, meeting transcripts, and illustrative figures into polished drafts that conform to legal, scientific, or industrial norms. Despite the availability of document automation tools and word processors, the integration of meaningful, context-aware content based on diverse information sources is a significant challenge. Existing systems may rely on rigid templates, keyword-based insertion, or rule-based engines that lack semantic understanding of context, tone, or technical nuance. As a result, the generated content may be frequently generic, disjointed, or require substantial human intervention to refine.

There is a need for a robust system that can produce high-quality technical drafts from existing of a variety of types while improving consistency, and enabling scalable document automation.

### SUMMARY

In some embodiments, a computer-implemented method is provided including receiving custom template material with static text and prompts; evaluating the prompts using an LLM to generate context-aware output based on input information material; generating a draft based on the custom template material by preserving the static text and replacing the prompts with the generated output in a context context-aware manner. The context-awareness may take into consideration a context of one or more static text surrounding/in close proximity to the respective prompt evaluated and/or a context of the section of the draft in which the prompt is being evaluated.

In some embodiments, systems and methods for automated generation of context-aware technical drafts using large language models (LLMs) are provided including a computer-implemented method and associated systems and computer program products for converting custom templates comprising static text and embedded prompts into coherent and contextually relevant technical drafts. These drafts may include documents such as patent applications, technical specifications, or reports. The method includes receiving custom template material that incorporates fixed static text and one or more prompts. These prompts are processed using a trained LLM, which evaluates them in light of provided input information material to generate corresponding context-aware outputs. The static text may be preserved, and the prompts may be replaced with generated outputs in a manner that respects the semantic and linguistic context of the surrounding static text. The system may operate using diverse forms of input information material, including invention disclosure documents, transcripts, claim sets, figures, audio, video, or live textual input. Context-aware instructions may also be provided to guide the LLM's response based on the section or purpose of the technical draft.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a block diagram of a network of data processing systems in accordance with an illustrative embodiment.

FIG. 2 depicts a block diagram of a computing environment in accordance with an illustrative embodiment.

FIG. 3 depicts a block diagram of a draft generation system in accordance with an illustrative embodiment.

FIG. 4 depicts a block diagram of a retrieval-augmented generation system in accordance with an illustrative embodiment.

FIG. 5 depicts a flowchart of a method of generating a technical draft document in accordance with an illustrative embodiment.

FIG. 6 depicts a flowchart of a method of generating a technical draft document in accordance with an illustrative embodiment.

FIG. 7 depicts a flowchart of a method of generating a custom input template in accordance with an illustrative embodiment.

FIG. 8 depicts a block diagram of a draft generation system in accordance with an illustrative embodiment.

FIG. 9 depicts a flowchart of a method of generating a context-aware output of figures in accordance with an illustrative embodiment.

FIG. 10 depicts a block diagram of a draft generation system in accordance with an illustrative embodiment.

FIG. 11 depicts a flowchart of a method of re-generating the draft in accordance with an illustrative embodiment.

FIG. 12 depicts a block diagram of a draft generation system in accordance with an illustrative embodiment.

FIG. 13 depicts a flowchart of a method of generating prompt in accordance with an illustrative embodiment.

### DETAILED DESCRIPTION

### Overview

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

It is recognized that drafting technical documents such as patents, technical reports, legal briefs, and other formal writings often requires not only significant manual effort and expertise, but more importantly, nuance. These are typically performed manually in a not only time-consuming manner but are also prone to inconsistencies and errors.

Embodiments of the present disclosure generally relate to a method and system for context-aware draft generation, comprising: receiving custom template material with static text and prompts; evaluating the prompts using an LLM to generate context-aware output based on input information material; generating a draft based on the custom template material by preserving the static text and replacing the prompts with the generated output in a context aware manner.

Certain operations are described as occurring at a certain component or location in an embodiment. Such locality of operations is not intended to be limiting on the illustrative embodiments. Any operation described herein as occurring at or performed by a particular component, can be implemented in such a manner that one component-specific function causes an operation to occur or be performed at another component, e.g., at a local or remote engine respectively. In one embodiment, the method described herein, is implemented to execute on a particularly configured computing device or data processing system and provides substantial advancement of the functionality of that computing device or data processing system. Embodiments thus have the capacity to improve the technical field of technical draft generation using large language models. For example, as opposed to using any LLM for text generation or merely providing instructions for generating an output, the illustrative embodiments can utilize collective decision making to manage several types and forms of input information material containing thousands of concepts or ideas with a careful observation and methodology. Thus, the performance of a drafting engine is optimized through automatically and dynamically executing standard and custom user prompts in a context aware manner using the input information material while preserving the relevancy of drafts and reducing or eliminating hallucinations. In some embodiments, the context awareness can be enhanced by predetermined additional context-aware instructions provided for sub-sections of the draft wherein a first prompt is executed differently for a first sub-section of the draft than the same first prompt is executed for a second sub-section of the draft. In some embodiments the provision of context-aware instructions to enhance the execution of standard and custom prompts provide a repeatable manner for automatically generating a significant number of technically relevant drafts while still maintaining close control of the style and form, and manner in which the drafts are generated.

Importantly, although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably processed manually by a human user.

The illustrative embodiments are described with respect to certain types of machines. The illustrative embodiments are also described with respect to other scenes, subjects, measurements, devices, data processing systems, environments, components, and applications only as examples. Any specific manifestations of these and other similar artifacts are not intended to be limiting to the disclosure. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures, therefore, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

### Example Data Processing Environment

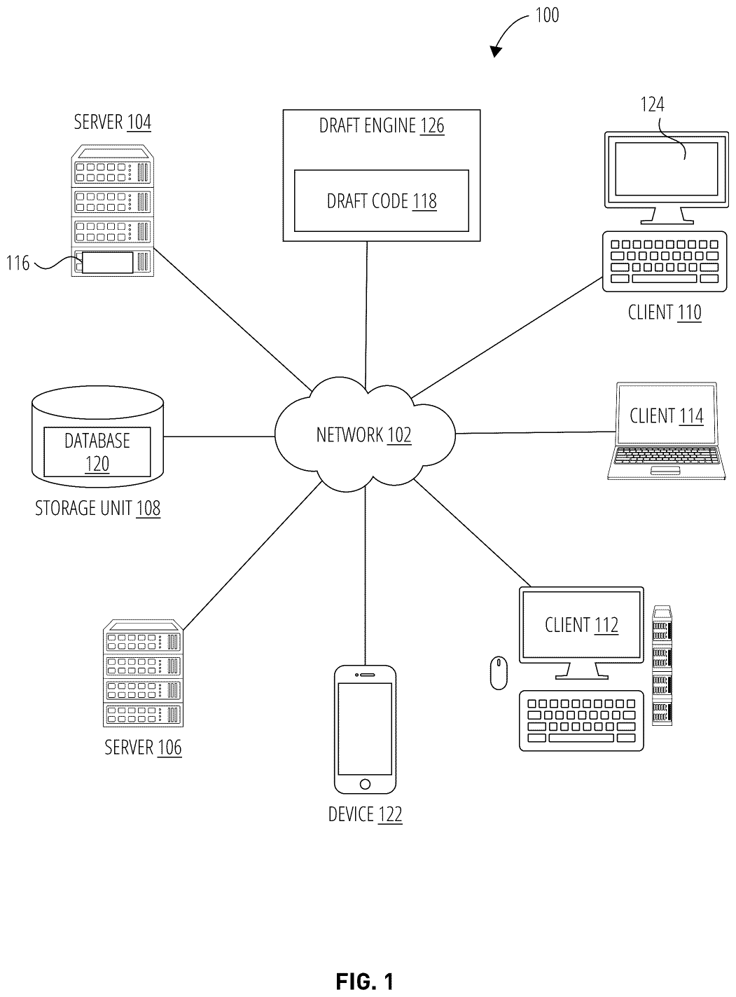

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Client 110, client 112, client 114 are also coupled to network 102. A data processing system, such as clients (client 110, client 112, client 114), draft engine 126, and device 122, may include data and may have software applications or software tools executing thereon.

Only as an example, and without implying any limitation to such architecture, FIG. 1 depicts certain components that are usable in an example implementation of an embodiment. Data processing systems (draft engine 126, server 104, server 106, client 110, client 112, client 114, and device 122) also represent example nodes in a cluster, partitions, and other configurations suitable for implementing an embodiment.

Server 104, server 106, storage unit 108, client 110, client 112, client 114, device 122, draft engine 126 may couple to network 102 using wired connections, wireless communication protocols, or other suitable data connectivity. Client 110, client 112 and client 114 may be, for example, personal computers or network computers. Any of the clients may include a client application 124.

In the depicted example, the servers may provide data, such as boot files, operating system images, and applications to client 110, client 112, and client 114. Client 110, client 112 and client 114 may be clients to servers in this example. Client 110, client 112 and client 114 or some combination thereof, may include their own data, boot files, operating system images, and applications. Data processing environment 100 may include additional servers, clients, and other devices that are not shown. Server 104 may include a server application 116 that may be configured to implement one or more of the functions described herein in accordance with one or more embodiments. Draft engine 126 may also be a part or separate from server 104 or server 106. Server application 116, and/or draft engine 126 may include draft code 118 configured for automatic technical draft generation.

Device 122 is an example of a device described herein. For example, device 122 can take the form of a smartphone, a tablet computer, a laptop computer, client 110 in a stationary or a portable form, or any other suitable device. Database 120 of storage unit 108 may store one or more information for operations herein.

The data processing environment 100 may also be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service-oriented architecture where interoperable software components distributed across a network may be packaged together as coherent business applications. Data processing environment 100 may take the form of a cloud and employ a cloud computing model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 200 includes an example of an environment for the execution of at least some of the computer code involved in performing the inventive methods, such as draft code 118. In addition to the draft code 118, computing environment 200 includes, for example, Computer 202, wide area network 228 (WAN), end user device 230 (EUD), remote server 232, public cloud 240, and private cloud 236. In this embodiment, Computer 202 includes processor set 204 (including processing circuitry 206 and cache 208), communication fabric 210, volatile memory 212, persistent storage 214 (including operating system 216 and the draft code 118, as identified above), peripheral device set 218 (including user interface (UI) device set 220, storage 222, and Internet of Things (IoT) sensor set 224), and network module 226. Remote server 232 includes remote database 234. Public cloud 240 includes gateway 238, cloud orchestration module 242, host physical machine set 246, virtual machine set 244, and container set 248.

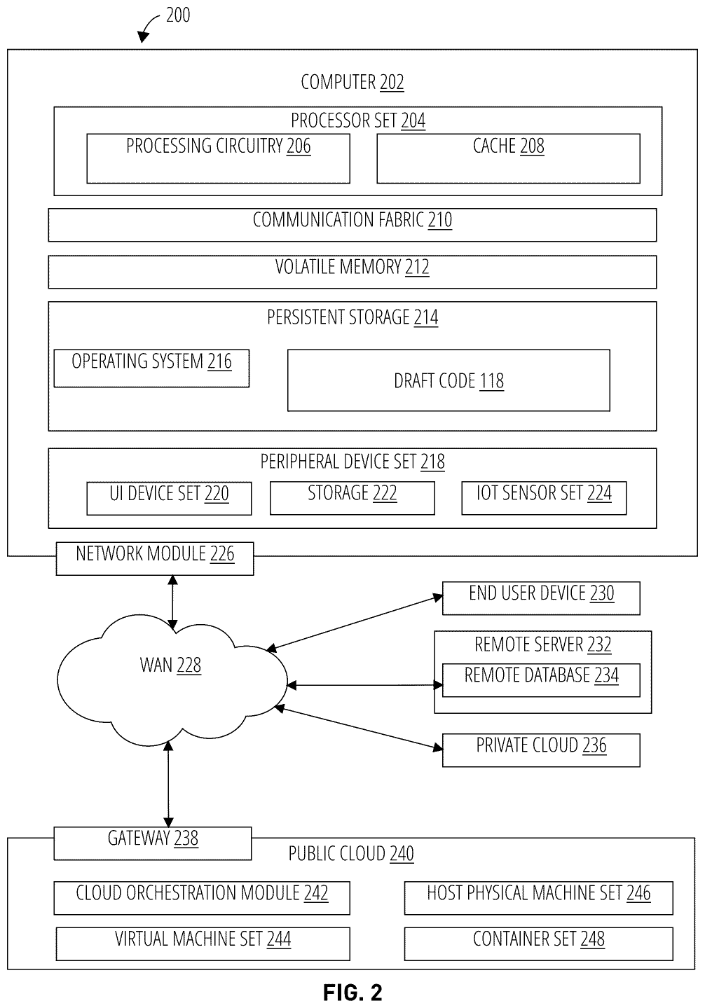

Computer 202 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 234. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically Computer 202, to keep the presentation as simple as possible. Computer 202 may be located in a cloud, even though it is not shown in a cloud in FIG. 2. On the other hand, Computer 202 is not required to be in a cloud except to any extent as may be affirmatively indicated.

Processor set 204 includes one, or more, computer processors of any type now known or to be developed in the future. Processing circuitry 206 may be distributed over multiple packages, for example, multiple, coordinated integrated circuit chips. Processing circuitry 206 may implement multiple processor threads and/or multiple processor cores. Cache 208 is memory that is located in the processor chip package(s) and is typically used for data or code that should be available for rapid access by the threads or cores running on processor set 204. Cache memories are typically organized into multiple levels depending upon relative proximity to the processing circuitry. Alternatively, some, or all, of the cache for the processor set may be located “off chip.” In some computing environments, processor set 204 may be designed for working with qubits and performing quantum computing.

Computer readable program instructions are typically loaded onto Computer 202 to cause a series of operational steps to be performed by processor set 204 of Computer 202 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 208 and the other storage media discussed below. The program instructions, and associated data, are accessed by processor set 204 to control and direct performance of the inventive methods. In computing environment 200, at least some of the instructions for performing the inventive methods may be stored in the draft code 118 in persistent storage 214.

Communication fabric 210 is the signal conduction path that allows the various components of Computer 202 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, volatile memory 212 is characterized by random access, but this is not required unless affirmatively indicated. In Computer 202, the volatile memory 212 is located in a single package and is internal to Computer 202, but, alternatively or additionally, the volatile memory may be distributed over multiple packages and/or located externally with respect to Computer 202.

Persistent storage 214 is any form of non-volatile storage for computers that is now known or to be developed in the future. The non-volatility of this storage means that the stored data is maintained regardless of whether power is being supplied to Computer 202 and/or directly to persistent storage 214. Persistent storage 214 may be a read only memory (ROM), but typically at least a portion of the persistent storage allows writing of data, deletion of data and re-writing of data. Some familiar forms of persistent storage include magnetic disks and solid-state storage devices. Operating system 216 may take several forms, such as various known proprietary operating systems or open-source Portable Operating System Interface-type operating systems that employ a kernel. The code included in the draft code 118 typically includes at least some of the computer code involved in performing the inventive methods.

Peripheral device set 218 includes the set of peripheral devices of Computer 202. Data communication connections between the peripheral devices and the other components of Computer 202 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 220 may include components such as a display screen, speaker, microphone, wearable devices (such as goggles and smart watches), keyboard, mouse, printer, touchpad, game controllers, and haptic devices. Storage 222 is external storage, such as an external hard drive, or insertable storage, such as an SD card. Storage 222 may be persistent and/or volatile. In some embodiments, storage 222 may take the form of a quantum computing storage device for storing data in the form of qubits. In embodiments where Computer 202 is required to have a large amount of storage (for example, where Computer 202 locally stores and manages a large database) then this storage may be provided by peripheral storage devices designed for storing very large amounts of data, such as a storage area network (SAN) that is shared by multiple, geographically distributed computers. IoT sensor set 224 is made up of sensors that can be used in Internet of Things applications.

Network module 226 is the collection of computer software, hardware, and firmware that allows Computer 202 to communicate with other computers through WAN 228. Network module 226 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 226 are performed on the same physical hardware device. In other embodiments (for example, embodiments that utilize software-defined networking (SDN)), the control functions and the forwarding functions of network module 226 are performed on physically separate devices, such that the control functions manage several different network hardware devices. Computer readable program instructions for performing the inventive methods can typically be downloaded to Computer 202 from an external computer or external storage device through a network adapter card or network interface included in network module 226.

WAN 228 is any wide area network (for example, the internet) capable of communicating computer data over non-local distances by any technology for communicating computer data, now known or to be developed in the future. In some embodiments, the WAN 228 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 230 is any computer system that is used and controlled by an end user (for example, a customer of an enterprise that operates Computer 202) and may take any of the forms discussed above in connection with Computer 202. EUD 230 typically receives helpful and useful data from the operations of Computer 202. For example, in a hypothetical case where Computer 202 is designed to provide a recommendation to an end user, this recommendation would typically be communicated from network module 226 of Computer 202 through WAN 228 to EUD 230. In this way, EUD 230 can display, or otherwise present, the recommendation to an end user. In some embodiments, EUD 230 may be a client device, such as thin client, heavy client, mainframe computer, desktop computer and so on.

Remote server 232 is any computer system that serves at least some data and/or functionality to Computer 202. Remote server 232 may be controlled and used by the same entity that operates Computer 202. Remote server 232 represents the machine(s) that collect and store helpful and useful data for use by other computers, such as Computer 202. For example, in a hypothetical case where Computer 202 is designed and programmed to provide a recommendation based on historical data, then this historical data may be provided to Computer 202 from remote database 234 of remote server 232.

Public cloud 240 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 240 is performed by the computer hardware and/or software of cloud orchestration module 242. The computing resources provided by public cloud 240 are typically implemented by virtual computing environments that run on various computers making up the computers of host physical machine set 246, which is the universe of physical computers in and/or available to public cloud 240. The virtual computing environments (VCEs) typically take the form of virtual machines from virtual machine set 244 and/or containers from container set 248. It is understood that these VCEs may be stored as images and may be transferred among and between the various physical machine hosts, either as images or after instantiation of the VCE. Cloud orchestration module 242 manages the transfer and storage of images, deploys new instantiations of VCEs and manages active instantiations of VCE deployments. Gateway 238 is the collection of computer software, hardware, and firmware that allows public cloud 240 to communicate through WAN 228.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 236 is similar to public cloud 240, except that the computing resources are only available for use by a single enterprise. While private cloud 236 is depicted as being in communication with WAN 228, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 240 and private cloud 236 are both part of a larger hybrid cloud.

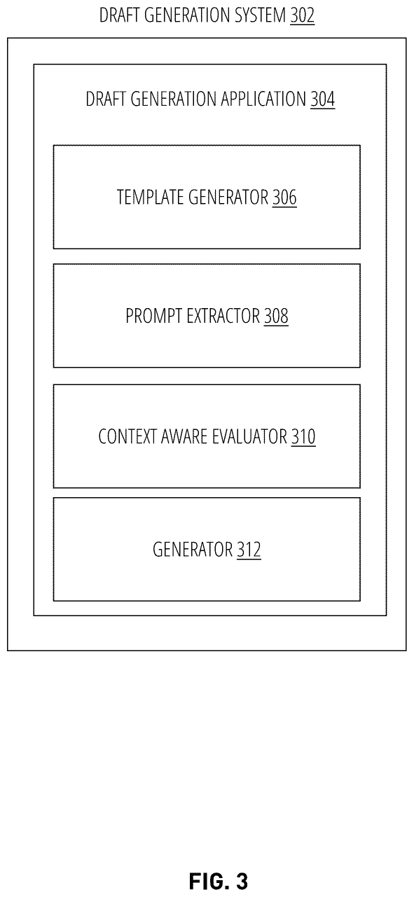

Reference is now made to FIG. 3 which illustrates an architecture of a draft generation system 302 in accordance with one or more embodiments. The draft generation system 302 may include a draft generation application 304 such as server application 116 or client application 124. The draft generation system 302 employ the use of the draft engine 126 for performing all or a subset of the functions herein. The draft engine 126 may be operated based on draft code 118 for automatic draft generation based on input information material and input template material.

The draft generation application 304 may be configured to enable the selection of portions of a draft produced by the draft generation application 304 such as text to expand the text, rephrase the text, or define the text (single terms) etc. The draft is generated based on at least a custom template (input template material, for example one generated by the template generator 306) that includes “static text” (fixed text that is constant and not meant to change or be updated) as well as prompts that are earmarked to be evaluated by an evaluator such as a context aware evaluator 310 (including, for example, an AI model/LLM and section-based context aware instructions) in a context aware manner. The prompts are standard prompts and custom prompts. The standard prompts are fixed terminology that correspond to respective predetermined instructions for execution by the LLM using information contained in a set of input information material (such as an invention disclosure file, a transcript, claims, etc., which can be in the form of a document, stored text object, input live text, input audio, video or other corpus). The standard prompts may be identified by standard prompt identifiers (for example, they are enclosed in, double square brackets).

The custom prompts are natural language instructions (user instructions) that may be combined with standard prompts, in which case the natural language instructions provide extra information about how the user wants the standard prompt to be adjusted for execution. The custom prompts are identified by custom prompt identifiers (for example, they are enclosed in, double curly brackets). A custom prompt can also be embedded inside a standard prompt.

In addition to taking in input information material, the draft generation application 304 also takes an input template material (which can be in the form of a document, stored text object, or other corpus) that provides the structure of the draft to be prepared by the software with regards to the positions of the static text (which are not changed) and prompts (which may be evaluated in a context aware manner and replaced with an output also in a context aware manner). Because the input template material can contain any static text and prompt, there can be many possible structures of the input template material that can be used. Further, the draft generation application 304 may include or receive additional context-aware instructions corresponding to different sections of the draft that dictate the manner in which the prompts are evaluated based on the section the prompt belongs to. In some embodiments, context models may be used by the context-aware evaluator 310 to collect context for adapting output, tailoring a set of application-relevant data, increasing the precision of information retrieved from input material, interpreting user interaction, or generating a cohesive technical draft. For example: a context-aware application may know that a custom prompt may be evaluated to get an output that will be placed between existing static texts in a technical draft and so a context of the surrounding static text is obtained and the output of the evaluated custom prompt is adapted to fit within the static text. This may also be performed on a larger scale for the entire technical draft or a portion thereof.

In some embodiments, additional context-aware instructions can define processing rules, stylistic conventions, weighting preferences, and semantic constraints that influence the manner in which prompts within the input template material are interpreted and evaluated. For example, a prompt located in a “Background” section of a patent draft may be processed differently than a prompt in a “Detailed Description” or “Summary” section, even when the same or similar input information material is used.

In some embodiments, the additional context-aware instructions are configured to weigh the relevance of one or more specific input information material more than others for draft generation.

In some embodiments, the context-aware instructions are configured to assign differential weights or relevance scores to various types of input information material uploaded by the user. These input materials may include, but are not limited to, technical disclosures, invention summaries, transcripts of inventor interviews or video recordings, prior art references, and previously drafted claims. The draft generation application 304 evaluates the contextual significance of each input material in relation to specific sections of the draft document and adjusts the influence of each accordingly during prompt evaluation by the context aware evaluator 310.

For example, with technical patent drafts in particular, when generating a “Brief Description of the Drawings” section, the draft generation application 304 may prioritize input information derived from figure-related annotations, spatial layouts, and image-derived metadata obtained through a figure processing module or figures processor (explained later within the specification). Conversely, when generating content for the “Claims” or “Detailed Description” sections, the draft generation application 304 may assign a higher relevancy score to technical disclosures and inventor transcripts that explain the structure, function, and operation of the invention. Similarly, previously drafted claims may be weighted highest when generating claim language or ensuring internal consistency. Of course, the example of a patent draft is not meant to be limiting as other technical drafts are possible in light of the descriptions herein.

In some embodiments, the relevancy or weight mechanisms may be driven by predefined rules, dynamically adjusted through learned patterns, or governed by metadata tags associated with each input information material. The weights can be applied at both document-level and segment-level, allowing the draft generation system 302 to finely tune the influence of specific portions of information material based on the requirements of the output section being generated in a context aware manner.

By incorporating such differential weighting of heterogeneous input sources, the draft generation application 304 ensures that the most relevant and context-appropriate content is emphasized during the natural language generation process. This contributes to the creation of more accurate, coherent, and section-specific drafts, thereby reducing reliance on manual post-processing and enhancing drafting efficiency.

The draft generation application 304 may be designed to provide to the user a list of possible Standard Prompts for the user to use in generating the input template material. The input template material may include the customer's own static text as well as the standard prompts placed in, for example, double square brackets such as: The embodiments disclose [[Background]]. In that example “The embodiments disclose” is static text and [[Background]] may be identified as a prompt due to the use of the predetermined prompt identifiers (double square brackets) and will be run by the LLM to generate an output text (corresponding to for example, the background description of the input information material, assuming that the term “Background” has been configured to have the meaning of a background description of the input information material) to replace the corresponding standard prompt in the generated draft. In some embodiments, the identifier for a standard prompt may be different from the identifier for a custom prompt that takes in user natural language instructions.

In some embodiments, the input template material can also have custom prompts which can be standalone or can complement the standard prompts. When the custom prompt is executed by the LLM, the output is likewise used to replace the corresponding custom prompt in the generated draft. An example use of a custom prompt is {{Discuss the background in less than 100 words}} or [[Background {{Discuss the background in less than 100 words}}]] or [[Background {{Discuss the background of car technology}}]]. In the first example the custom prompt is standalone and can be executed by the LLM as a direct instruction without a need to interpret the meaning of the text beforehand. The other two examples combine the custom prompt with a standard prompt. In this case, the predetermined meaning of the standard prompt is obtained, and the custom prompt is used to modify or complement the meaning or requirements of the standard prompt, and the final meaning or requirements are then provided to the LLM for execution. The output produced is then used to replace the prompt in the draft generated in a context-aware manner without changing surrounding static text. The draft generation can be performed by the generator 312.

So, in essence, the draft generation application 304 is designed to allow the user to provide (such as upload, or type in real time) the input template material that comprises static texts as well as the standard prompts in standard prompt identifiers and custom prompts in custom prompt identifiers. The standard prompts have a predetermined meaning, and the custom prompts are dynamic and can include natural language instructions that do not have to be pre-interpreted unlike the standard prompts. The use of different prompt identifiers may make it possible to differentiate standard prompts from custom prompts or other types of prompts.

The LLM output for the prompts is added into the static text at the position occupied by the corresponding prompt in a context aware manner that preserves the static text but may slightly modify the LLM output without losing context so as to preserve the formatting of the static text.

In an example that is alternative to allowing the user to upload an input template document, a UI can be created for the user to generate their input template directly in the draft generation application 304. This can be done by the user by typing or pasting in the static text and the prompts to generate an input template material which will be used by the draft generation application 304 to generate drafts along with the input information material.

### Features

The LLM may in general be an ML model. The draft generation application 304 may be configured to utilize one or more large language model (LLMs) for generating one or more sections of the draft in a context aware manner. The draft engine 126 may include one or more large language model (LLMs) that are used by the draft generation application 304 for at least figure interpretations, figure preparations, transcript generation, and context aware document production based on the input information material and the input template material. In some embodiments, the LLMs are selected by the draft generation application 304 based on the type, section, or structure of the draft to be generated.

In some embodiments, the draft generation application 304 may invoke a general-purpose LLM, such as a transformer-based language model, to generate content for multiple sections of the draft, such as the background, summary, detailed description, and claims. The general-purpose LLM may be pre-trained on diverse datasets and optionally fine-tuned on technical and legal corpora to generate contextually appropriate and legally compliant output.

In some embodiments, the draft generation application 304 may include or access domain-specific LLMs fine-tuned on corpora related to the desired technical domain, such as granted patent specifications, prosecution history records, claim language templates, or FDA 510(k) submissions, etc, across one or more jurisdictions. Such LLMs may be configured to generate output aligned with jurisdiction-specific drafting norms and terminology.

In some embodiments, the draft generation application 304 may also utilize multilingual or translation-capable LLMs for processing input information material in non-English languages, such as inventor disclosures, foreign patent applications, or oral transcripts. The multilingual LLM may translate such material into English in a context-aware manner and generate section-wise content accordingly. Example models include mBART, NLLB, or any encoder-decoder LLM architecture suitable for multilingual drafting tasks.

In some embodiments, the draft generation application 304 may include or invoke a retrieval-augmented generation (RAG) LLM that retrieves supplementary technical references or patent-related documents from one or more external or internal databases. The LLM may then generate output conditioned on both the input information material and retrieved documents. This configuration may be used, for example, when generating prior art comparisons, claim support language, or technical field overviews.

In an exemplary embodiment, the draft generation application 304 may further employ instruction-tuned or task-optimized LLMs to refine user input information or provide real-time drafting assistance. Such models may be configured to receive user-entered prompts, suggest completion options, identify incomplete technical content, or enforce stylistic and structural conformity across various sections of the draft. In another exemplary embodiment, the draft generation application 304 may employ a modular architecture, wherein different LLMs are assigned to specific subtasks in the drafting process. For instance, a first LLM may be used for summarizing technical disclosures, a second LLM may be used for elaborating claims, and a third LLM may be used for generating context-specific transitions or formatting adjustments in the draft in a cascade manner.

Further, the draft generation application 304 may utilize context-aware instructions to determine which type of LLM is best suited for evaluating a particular prompt contained within the input template material. The context-aware instructions may further assign weights to different input information materials based on their relevance to the section being generated.

In some embodiments, a refinement model such as a micro-LLM or lightweight transformer may be applied as a post-processing step. These refinement model may be configured to ensure internal consistency, resolve coreferences, harmonize terminology, or adjust formatting to conform to jurisdiction-specific requirements.

Accordingly, the draft generation application may be configured to operate with a plurality of LLMs, each selectively activated, weighted, or tuned in order to ensure high-quality, context-aware, and section-specific generation of a draft document, thereby reducing manual drafting effort and improving compliance, consistency, and precision in the resulting patent specification or related technical document.

In one example, the LLMs are a Context-Aware Generative AI.

Context awareness as used herein can in some cases refer to the use of any combination of linguistic models, tools, or systems to understand and utilize the surrounding text or speech in a material to enhance performance in various tasks. This can include recognizing the relationship between words, sentences, and larger text structures to improve tasks such as:
Word Sense Disambiguation: Identifying the correct meaning of a word based on its context. For example, the word “bank” can refer to a financial institution or the side of a river, and context helps determine the intended meaning.
Named Entity Recognition (NER): Detecting and classifying proper nouns (like names of people, organizations, locations) within a text. Context helps to differentiate whether “Apple” refers to the fruit or the technology company.
Coreference Resolution: Identifying when different expressions refer to the same entity. For instance, recognizing that “she” and “Mary” in a text might refer to the same person.
Contextual Translation: Enhancing machine translation by considering the context in which a phrase appears, leading to more accurate translations.
Semantic Parsing: Understanding the meaning of a sentence by considering the relationships between words and phrases, which helps in extracting the intended message.
Sentiment Analysis: Determining the sentiment (positive, negative, neutral) expressed in a piece of text by considering the surrounding context, which affects the interpretation of words and phrases.

The linguistic models, tools, or systems can be various computational and theoretical frameworks, software, and algorithms used in the field of linguistics and natural language processing (NLP) to analyze, understand, and generate human language. NLP can enable the recognition, understanding and generation of text and speech by combining computational linguistics, which is the rule-based modeling of human language, together with statistical modeling, machine learning (ML) and deep learning. NLP as used herein further comprises generative AI including large language models (LLMs) and image generation models.

In general, the linguistic models, tools, or systems include the following:
A. Linguistic Models:
   Statistical Models: These use statistical methods to predict linguistic patterns. Examples include n-gram models for predicting the next word in a sequence based on previous words.
   Machine Learning Models: These learn from large datasets to perform tasks like text classification, sentiment analysis, and machine translation. Examples include Support Vector Machines (SVM), Decision Trees, and neural networks.
   Deep Learning Models: A subset of machine learning models that use neural networks with multiple layers (e.g., Recurrent Neural Networks (RNNs), Long Short-Term Memory networks (LSTMs), and Transformers) to capture complex patterns in language data.
B. Linguistic Tools:
   Text Analyzers: Software that performs various types of text analysis, such as tokenization, part-of-speech tagging, and syntactic parsing.
   Corpus Management Systems: Tools for compiling, managing, and querying linguistic corpora (large collections of text).
   Annotation Tools: Software for manually annotating text with linguistic information, such as named entities, syntactic structures, or semantic roles.
C. Linguistic Systems:
   Machine Translation Systems: Systems that automatically translate text from one language to another
   Speech Recognition Systems: Systems that convert spoken language into text, like those used in virtual assistants
   Chatbots and Conversational Agents: Systems designed to engage in human-like conversations, such as customer service bots or virtual therapists.
   Information Retrieval Systems: Systems that extract relevant information from large datasets or the web, like search engines.

The draft generation application 304 is designed based on combinations of these linguistic models, tools, and systems to leverage context awareness to improve performance and accuracy of understanding natural language and generating relevant drafts. In some embodiments, the machine learning models may be trained using data from the technical field or relevance.

In some embodiments, the extraction of prompts is performed with a prompt extractor 308. For instance, the draft generation application 304 may utilize a prompt extractor 308 to identify and isolate prompts embedded within the input template material. The prompt extractor 308 is configured to parse the input template material and distinguish between static text, standard prompts, and custom prompts based on pre-defined prompt identifiers. Specifically, standard prompts are demarcated by standard prompt identifiers (e.g., double square brackets [[ . . . ]]), while custom prompts are marked using custom prompt identifiers (e.g., double curly brackets {{ . . . }}), as discussed earlier.

Upon receiving the input template material, the prompt extractor 308 performs a token-level or pattern-based analysis to extract all prompt expressions from the surrounding static text. This extraction process help to enable context-aware evaluation by the context-aware evaluator 310, which employs a language model (LLM) for natural language generation.

In some embodiments, the extracted standard prompts are matched against a predefined prompt dictionary or prompt meaning repository to determine their associated instructional meaning, while the custom prompts are interpreted directly as natural language instructions. In scenarios where a standard prompt is combined with a custom prompt, the prompt extractor 308 is further configured to isolate both components, associate the custom prompt with its corresponding standard prompt, and package the pair into a structured data format (e.g., a prompt-object pair) for downstream processing.

The prompt extractor 308 may further support handling nested or hierarchical prompts by applying a recursive or depth-first parsing logic to ensure proper delimitation of embedded custom prompts within standard prompts. This enables flexible and complex template configurations where users can tailor standard prompt execution behavior through natural language modifications.

Additionally, the prompt extractor 308 may generate a prompt map or prompt index that tracks the position of each extracted prompt within the input template material. This positional metadata is used during reinsertion of the LLM-generated content into the original template to ensure the static structure is preserved while replacing prompts with corresponding outputs in a context-aware manner.

In this manner, prompt extractor 308 enables intelligent and modular preprocessing of template content, facilitating a seamless interaction between template-driven document generation and LLM-based contextual drafting, all while preserving user-defined structure and intent.

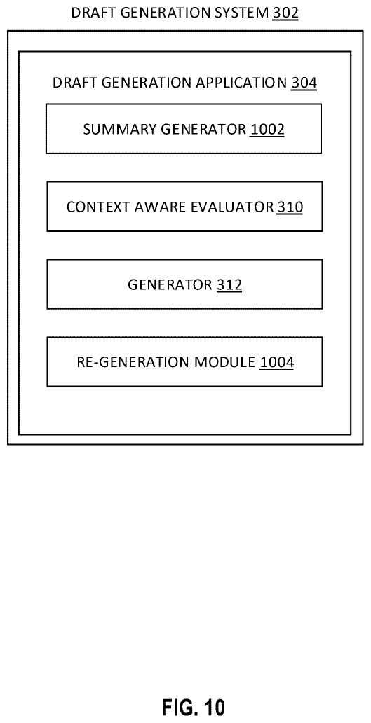

In some embodiments, the draft generation application 304 may include a summary module or summary generator 1002, as shown in FIG. 10, and configured to process input information documents and generate a summary thereof. The input information documents may include technical disclosure text, user-provided invention details, template content, drawing-related descriptions, or previously generated drafts. The summary module is operable to analyse the content of such documents and generate a condensed textual representation or abstract that captures the salient technical features and inventive concepts conveyed therein.

The draft generation application 304 may further include an agent component designed to intelligently manage the execution of tasks involving one or more language models (LLMs) or associated tools. The agent is configured to receive user inputs, such as prompts containing drafting instructions or content queries, and dynamically determine an execution strategy based on the complexity, intent, and content of the prompt.

In some embodiments, the agent may operate in conjunction with a tool router or LLM router, which is responsible for routing the prompt to the appropriate LLM or tool instance. The tool router may analyze the context of the prompt to identify whether it necessitates, for example, figure interpretation, technical text generation, prior art summarization, or claim drafting. Based on this analysis, the router may invoke one or more tools or LLMs capable of fulfilling the requested task.

The agent may be configured to handle a dynamic or undefined chain of operations, where the sequence and type of tasks to be executed are not known in advance. Upon receipt of a prompt, the agent may parse the input, determine a sequence of required actions (e.g., summarization, classification, prompt expansion, figure interpretation), and orchestrate calls to the appropriate modules or LLMs accordingly. In an embodiment, the agent may maintain stateful context tracking across multiple LLM invocations to preserve coherence and intent in the generated output.

For example, if a user provides a prompt instructing the system to generate a detailed description of a circuit diagram, the tool router may detect that the task involves visual figure analysis, and may accordingly invoke a figure interpretation tool or a vision-capable LLM to process the diagram input. The output of the visual model may then be passed back to the agent, which may combine it with template-based instructions and route it to a general-purpose LLM for drafting a specification-compliant paragraph. In some embodiments, the prompts may be provided in a live manner.

In some embodiments, the agent, together with the LLM router and summary module, enables context-aware orchestration of complex drafting operations by modularly interfacing with multiple specialized tools and models in response to user instructions.

According to some embodiments, the draft generation application 304 may further employ a re-generation module or a modification module 1004, as shown in FIG. 10. The modification module may be configured to receive input natural language to modify the generated sections of the draft by the generator 312 in a context aware manner. For example, the draft generation application 302 provides a user interface for the selection of a text by the user for the modification. Further, the draft generation application 302 may receive context aware instructions corresponding to the selected text or section based on which the re-generation module may replace, updated or append the selection text with the context-aware new text.

In some cases, the prompts not only provide one-time instructions for the LLM output generations but also provide further instructions such as a second set of instructions to use along with a first LLM output to generate a second LLM output.

For example, a first set of instructions may include pinpointing a general field of technology to which an input corpus of material belongs to, and the second set of instructions include generating background information about the general field. By the multiple step process, input information for the LLM can be precisely controlled to reduce or eliminate hallucination or irrelevant outputs.

The LLM may be further trained, tuned or configured to utilize the style of a user, such as the drafting style of the user, choice of terminology, sentence structure, or otherwise any retrievable or observable style. In some embodiments, the style is obtained through the input template material or a style document configured to aggregate relevant styles. In some embodiments, the input template material, therefore, comprises at least a portion that highlights the style. In some embodiments, a first output of the LLM in response to a prompt does not utilize the style. The output is then adapted to the style by providing the output to a style adapter module (which can be the same LLM or another LLM for the adaptation). In other embodiments, significant portions of the draft, such as entire sections with minimal associated static text, may be generated based on the style of a user. By training a machine learning model to generate relatively larger outputs based on the user style or sample complete manually prepared user drafts, the effort needed to prepare lengthy templates may be obviated. In other embodiments, a machine learning model may be trained to automatically detect, from sample complete, manually prepared user drafts, text likely to correspond to static text and text likely to correspond to prompts, and to automatically generate a template based on the automatic detection. The text likely to correspond to prompts may be determined based on, for example, a computation that the text is specific to a detected purpose or context of the complete, manually prepared user drafts. The text likely to correspond to static text may be determined based on, for example, a computation that the text is general-purpose text. By assigning likelihood score to the determinations, scores that exceed predetermined threshold values may be used to automatically generate an input template comprising static text and prompts for use in future draft generations for the user.

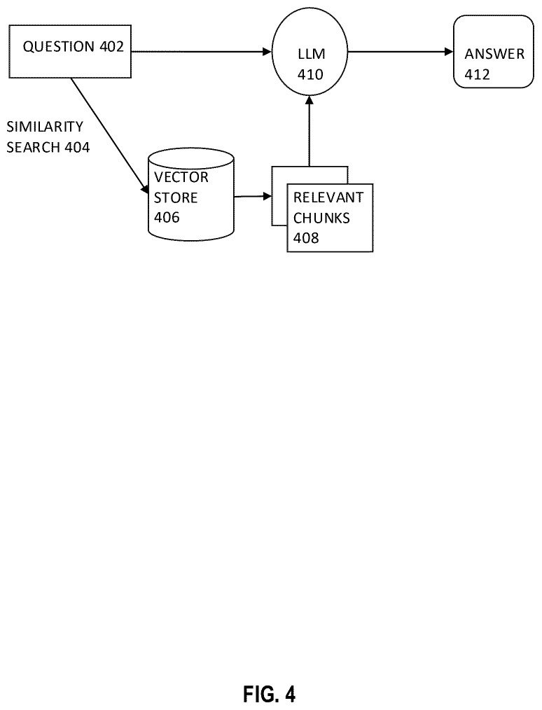

Referring now to FIG. 4, an example system is shown depicting a large language model (LLM) 410 combined with a vector-based retrieval mechanism to generate draft sections of a technical draft. A question 402 or instruction may be provided as input. In some embodiments, each portion or section of the technical draft (e.g., background, summary) may have an associated question 402 or instruction. This question 402 may be crafted to guide the LLM 410 in generating the corresponding text. Examples may include: “What is the technical problem the invention solves?”, “Describe the structure of the invention.” A similarity search 404 may be conducted via a Vectorstore 406. Specifically, the question 402 may be used to query the vectorstore 406, which may contain semantically embedded representations of source files such as: FDA trials, an invention disclosure, technical diagrams, a video call etc. Using similarity search, the system may retrieve the most relevant chunks 408 of text from vectorstore 406. The retrieved relevant chunks 408 may be collected to provide useful context for answering the question. Thus, the system may feed both the question 402 and the retrieved relevant chunks 408 into the LLM. This combination allows the model to generate informed, contextually accurate responses. The LLM 410 may processes the input and produces a answer 412 or output, which becomes the content for a section or a whole of the technical draft. Of course, this example is not meant to be limiting as other examples may be obtained in light of the disclosure.

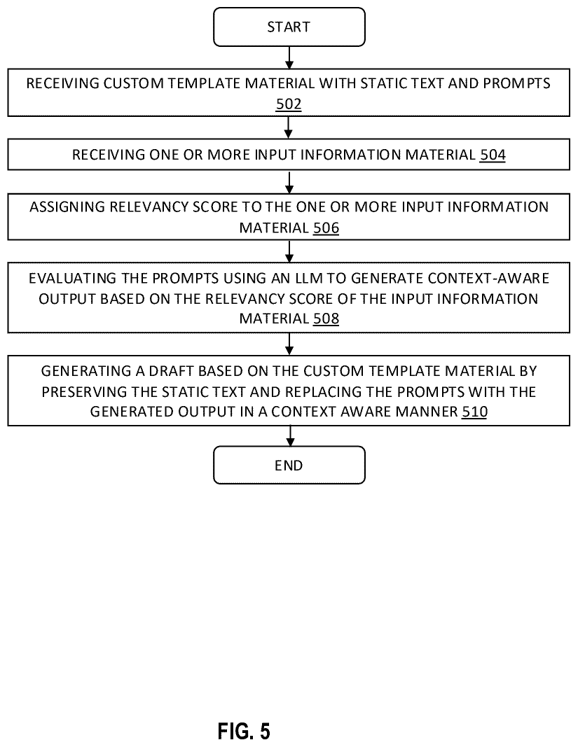

Referring now to FIG. 5, a method of generating a technical draft according to some embodiments is disclosed. The method comprises receiving a custom template material with a static text and prompts, at block 502. For example, the draft generation application 304 provides a user interface to enable the user to upload a custom template material that includes a static text which is fixed and does not change, and prompts which is replaced with the context aware output upon evaluation of the prompts using the LLM. The static text may be a boilerplate language that are common in all the drafts. For instance, the custom template material may include static text such as “The present invention relates to the field of,” followed by a prompt such as “[[Insert technical field]].”

Further, the method comprises receiving one or more input information material, at block 504. For example, the draft generation application 304 provides a user interface to enable the user to upload the one or more input information material that may explain the purpose or technicalities for which the draft is being generated. For instance, the one or more input information material may include technical documents, flowcharts, drawings, invention disclosures, textual descriptions, set of claims, videos, images, or transcript, etc. related to the invention in case of generation of a patent draft. Similarly, in case of generation of any other document, a technical or a contextual information associated with the same may be inputted as the input information material.

Further, the method may optionally comprise assigning the relevancy score or weight to each of the input information material, at block 506. For example, the draft generation application 304 may analyze each of the input information material to determine the contextual relevancy of the content of the input information material with the invention. Further, the draft generation application 304 may analyze the input information material to determine the portions of the input information material that may be most relevant for the generation of specific sections of the draft. Accordingly, the draft generation application 304 assigns the weight or relevancy score to each of the input information material. For example, the draft generation application 304 may assign higher weight or relevancy score to the set of claims compared to the transcript if uploaded as part of the input information material.

The draft generation application 304 may determine the relevancy score by performing a semantic similarity evaluation between each prompt within the custom template material and different segments of the input information material, optionally using vector-based embedding and similarity search algorithm. For example, a paragraph discussing “AI based image interpretation” within the input information material may receive a higher relevancy score or weight for a prompt associated to “technical field” than a figure related to mechanical components.

The method further comprises evaluating the prompts using an LLM to generate context-aware output based on the relevancy score of the input information material, at block 508. For example, the draft generation application 304 using the context-aware evaluator 310 employing the LLM, evaluates the prompts in a context-aware manner based on the input on their weightage for the generation of each section of the draft, as explained above.

Accordingly, generates a draft based on the custom template material by preserving the static text and replacing the prompts with the generated output in a context aware manner, at block 510.

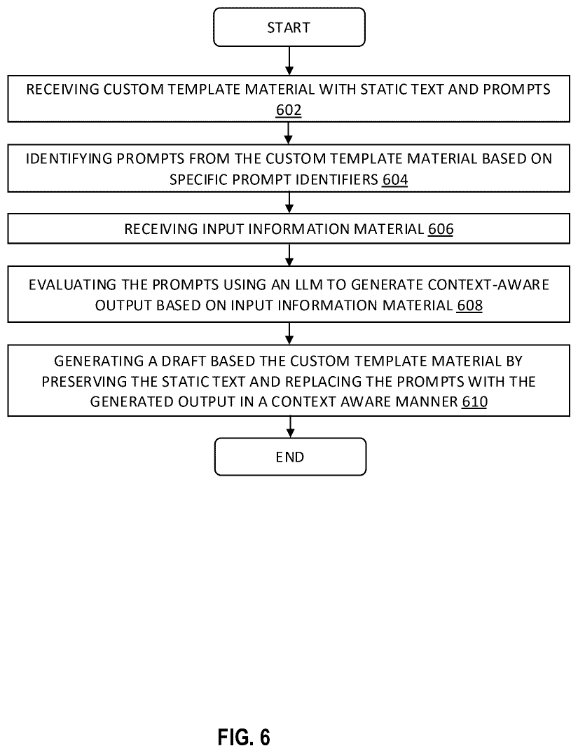

Referring now to FIG. 6, in some embodiments of the present disclosure, the method comprises receiving a custom template material with a static text and prompts, at block 602. For example, the draft generation application 304 provides a user interface to enable the user to upload a custom template material that includes a static text which is fixed and does not change, and prompts which is replaced with the context aware output upon evaluation of the prompts using the LLM. The static text may be a boilerplate language that are common in all the drafts. For instance, the custom template material may include static text such as “The present invention relates to the field of,” followed by a prompt such as “[[Insert technical field]].”

Further, the method comprises identifying prompts from the custom template material based on specific prompt identifiers, at block 604. For example, upon receiving the custom template material, the draft generation application 304 proceeds to identify and distinguish between the static text and prompts embedded within the template. The identification of prompts involves parsing the template content and detecting prompts within specific prompt identifiers (i.e. double brackets or double curly brackets).

In an alternate embodiment, in case the custom template material does not include prompt identifiers, the draft generation application 304 identifies prompts by parsing a content of the custom template material and detecting specific syntactic, semantic, or markup-based patterns that indicate dynamic content placeholders or prompts. Traditionally, the custom template material may be provided in any structured format such as plain text (.txt), rich text (.rft), word processing formats (.docx, .odt), markup formats (HTML, XML, JSON), or custom domain-specific template languages. The custom template material shall contain two elements such as the static text (that remains unaltered in the final draft) and the prompts (that are questions based on which the output is to be generated in a context aware manner).

Upon receipt of such custom template material without prompt identifiers, the draft generation application 304 parses the content of the template into a structured representation, such as a tokenized string array, document object mode (DOM) or abstract syntax tree (AST) depending on the format of the template. For example, the word (.docx) template may be parsed using an OpenXML or DOCX parser to extract paragraphs, runs, and text elements. The draft generation application 304 then scans the parsed content to identify tokens or segments that matches pre-defined prompt patterns. This includes identifying delimiters-based prompts (e.g. {{Insert technical field}}, <<Background section>>, or [Describe problem]), identifying keyword indicators (e.g. sentences beginning with “prompt”, “to be filled”, or containing “Insert [x]”), identifying tagged prompts (e.g. <prompt id=“001”>Describe system</prompt> in XML or HTML), or identifying structured field identifiers, such as JSON keys like “prompt field”: “Describe prior art”.

The draft generation application 304 applied regular expression matching, template grammar rules, or heuristic string analysis to detect and extract the tokens or segments.

Further, the draft generation application 304 may optionally apply the LLM to validate that the identified segments are indeed prompts. This contextual verification is useful when the template is ambiguously formatted, prompts are embedded within a sentence, or prompt identifiers are missing but inferred by context (e.g., this section describes [xyz])

Additionally, the draft generation application 304 assigns metadata to each identified prompt. For example, the identified prompts are associated with prompt text (e.g., “insert background”), location/position of the prompt in the template, type or category of prompt (e.g., “field name”, “invention summary”, “claim introduction”), and unique ID or anchor for mapping the generated output later. This assigned metadata allows the prompt to be dynamically matched with the corresponding LLM-generated output during the draft generation block.

Further, the method comprises receiving one or more input information material, at block 606. For example, the draft generation application 304 provides a user interface to enable the user to upload the one or more input information material that may explain the purpose or technicalities for which the draft is being generated. For instance, the one or more input information material may include technical documents, flowcharts, drawings, invention disclosures, textual descriptions, set of claims, videos, images, or transcript, etc. related to the invention in case of generation of a patent draft. Similarly, in case of generation of any other document, a technical or a contextual information associated with the same may be input as the input information material.

The method further comprises evaluating the prompts using an LLM to generate context-aware output based on the relevancy score of the input information material, at block 608. For example, the draft generation application 304 using the context-aware evaluator 310 employing the LLM, evaluates the prompts in a context-aware manner based on the input on their weightage for the generation of each section of the draft, as explained above.

Accordingly, generates a draft based on the custom template material by preserving the static text and replacing the prompts with the generated output in a context aware manner, at block 610.

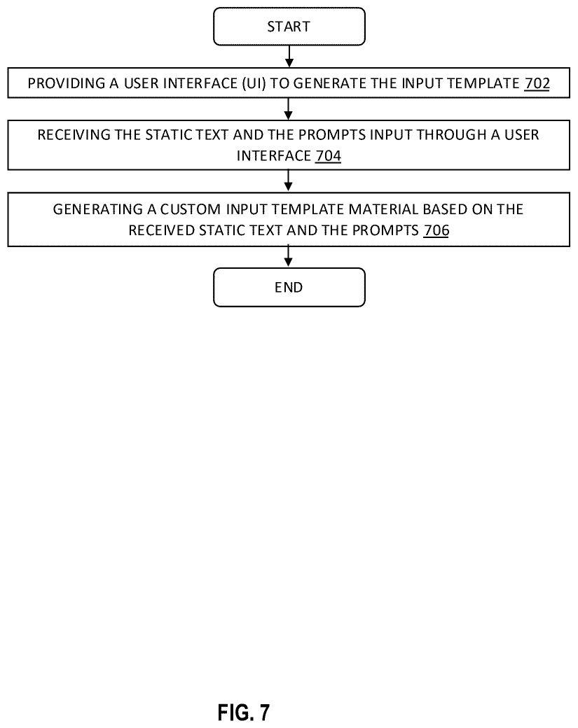

FIG. 7 is a flowchart of a method of generating a custom input template in accordance with an illustrative embodiment. Referring to FIG. 7, the method comprises providing a user interface (UI) to generate the input template material, at block 702. For example, the draft generation application 304 provides a user interface (UI) configured to facilitate the creation of an input template by a user. The UI may be implemented as a web-based form, desktop application, integrated development environment (IDE) plug-in, or any graphical/text-based interface. The UI allows users to input content intended to be part of a reusable or semi-automated document structure. Particularly, the UI enables the user to enter static text, which is content that remains unchanged across draft generation (e.g., boilerplate legal phrases or paragraphs, headers), and specific prompts, which includes standard prompts and custom prompts, and acts as a placeholders for variable content to be dynamically generated later based on an application of LLM in a context aware manner. The prompts may be manually entered by the user or a library of predefined prompt types (e.g., “Insert Background,” “Technical Field,” “Advantages”) may be provided for easy selection of the prompt from the library.

The method further comprises receiving the static text and the prompts input through a user interface, at block 704. For example, the draft generation application 304 receives the static text and the prompts entered by the user through the UI. This input may be collected as raw text, structured fields, or tagged content. Further, the draft generation application 304 generates the custom template by classifying each portion as either static text or prompt text. The draft generation application 304 may internally tag the prompts with unique identifiers, delimiters (e.g., {{ }}), or embedded metadata to maintain positional and contextual relationship between static and dynamic sections. For instance, the user may input the following into the UI “The present invention relates to the field of {{technical field}}. It addresses the problem of {{existing problem}}.” Here, “The present invention relates to the field of” and “It addresses the problem of” are static text, while {{technical field}} and {{existing problem}} are identified as prompts.

Finally, the method comprises generating a custom input template material based on the received static text and the prompts, at block 706. The draft generation application 304 then combines the received static text and the identified prompts to generate a structured custom input template material. The draft generation application 304 stores or export the generated custom input template to a database, local memory, or cloud storage for subsequent use, versioning, or sharing. Further, the draft generation application 304 processes the custom input template using the LLM to generate the context aware output, based on the input information material.

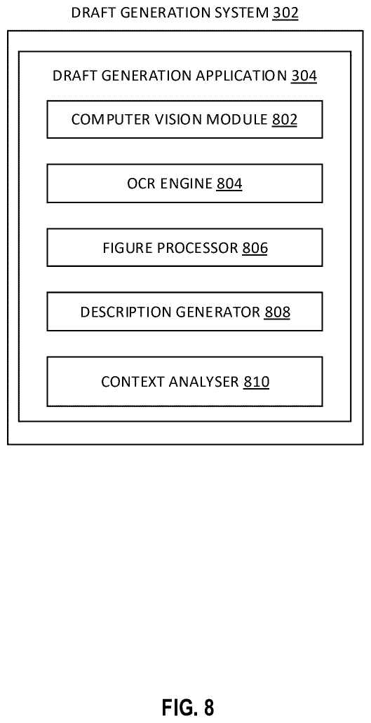

Reference is now made to FIG. 8 which illustrates architecture of a draft generation system 302 in accordance with one or more embodiments. The draft generation application 304 may comprise or be operatively coupled with multiple specialized modules including a computer vision module 802, an OCR engine 804, a figure processor 806, a description generator 808, and a context analyser 810. These modules may work collectively to receive, process, and evaluate information material, specifically interpret visual content uploaded as part of the input information material, to generate the draft text in a context-aware and template-aligned manner. The visual content comprising technical illustrations such as block diagrams, flowcharts, circuit diagrams, architectural schematics, system diagrams, and line-art-based figures typically found in patent specifications, research publications, or technical design documents

In some embodiments, the draft generation application 304 is designed to receive an input template material that includes both static text (unchanging predefined content) and dynamic prompt placeholders (which are evaluated in a context-sensitive way to generate output). The identification of these prompts from within the custom template material is performed via a combination of the computer vision module 802, OCR engine 804, and context analyser 810.

The figure processor 806 may receive one or more input figures in raster or vector-based image formats (e.g., PNG, JPEG, SVG, PDF). The figure processor 806 may utilize the computer vision module 802 to detect, identify, and interpret individual graphical elements and embedded textual annotations. The computer vision module 802 may employ architectures such as convolutional neural networks (CNNs), vision transformers (ViTs), hybrid encoder models, or graph-based neural networks (GNNs), trained on datasets containing labeled figures and corresponding semantic representations.

In some embodiments, the figure processor 806 may also employ the OCR engine 804 to detect and extract textual content embedded within the figures, including component labels, reference numerals, arrow annotations, axis labels, and instructional tags. The extracted text may be spatially aligned with graphical regions using bounding box metadata and clustering techniques.

Further, the figure processor 806 may utilize layout-aware architectures such as LayoutLM, LayoutLMv2/v3, or DocFormer to model spatial relationships between visual and textual components. These models process positionally encoded embeddings to derive context-rich representations of interconnected elements in a figure.

Using such modeling, the figure processor 806 may generate structured semantic data representing functional and topological relationships among figure elements. For example, in a system diagram, the module may output a representation such as: “Module A receives an input from Module B and processes it to produce Output C.”

The output of the figure processor 806 is transmitted to the description generator 808. The description generator 808 may incorporate a natural language generation (NLG) engine or transformer-based language model, and pre-trained or fine-tuned on corpora of technical drafting data. The description generator 808 converts figure-derived data into descriptive text formatted according to input template material.

The description generator 808 may produce structured content suitable for insertion under specific draft sections with headings, such as “Brief Description of the Drawings,” “Detailed Description,” or “System Overview.” For example, the generated output may read: “As illustrated in FIG. 2, the system includes a processor 202, a memory unit 204, and a communication interface 206, where the processor is configured to execute . . . ”

In some embodiments, a context analyser 810 may be used to ensure consistency between the description generated by the description generator 808 and the rest of the draft document. The context analyser 810 may align terminology and technical phrasing across claims, background, and summary sections by comparing vocabulary, functional terms, and reference labels.

The draft generation application 304, including the figure processor 806 and description generator 808, may operate in an interactive or automated mode. In interactive mode, human authors can edit or approve content. In autonomous mode, the modules may batch-process multiple figures to generate draft-ready sections for the final draft document.

Additionally, the system may support multiple technical domains by incorporating domain-specific model configurations or prompt-based specialization. This may allow the accurate interpretation and drafting of figures from areas such as electronics, software, mechanical systems, or biomedical designs, etc.

Each of these modules within the draft generation application 304 may be implemented as software algorithms executed by one or more processors within the draft engine 126. In some embodiments, these modules may be embodied as discrete software components, microservices, or scripts operating on a cloud-based or local computing platform. For example, the OCR engine 804 may use open-source software libraries like Tesseract or commercial APIs. Further, the computer vision module 802 may be implemented using TensorFlow-based CNNs or deployed on edge inference chips. Whereas the context analyser 810 may be realized as a rules-based engine or transformer model integrated with a document management system.

Alternatively, or in combination, one or more of the modules may be implemented using hardware-based components, such as field-programmable gate arrays (FPGAs), application-specific integrated circuits (ASICs), or dedicated embedded systems optimized for image processing, language modeling, or text parsing operations. For example, the computer vision module 802 may be accelerated using a GPU-optimized neural network engine, whereas the OCR engine 804 may be implemented using an ASIC-based optical recognition processor for enhanced throughput. The specific implementation may vary depending on deployment requirements, performance constraints, or design preferences, and all such variations are considered to be within the scope of the present disclosure.

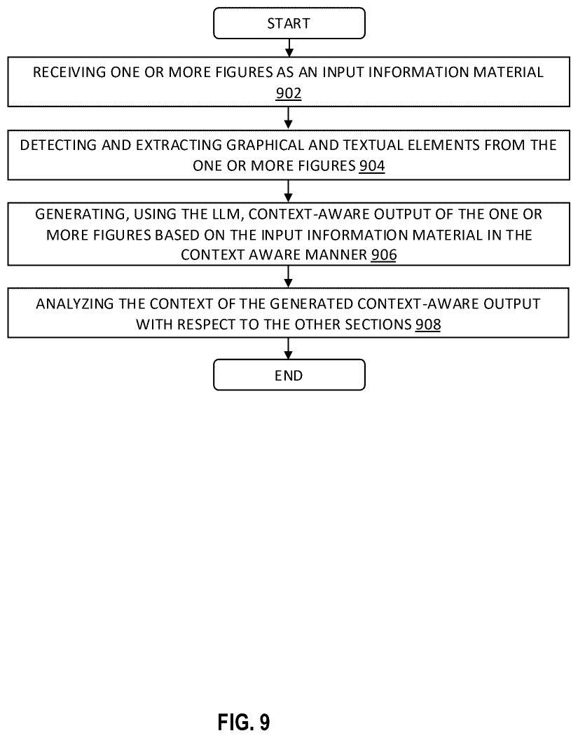

Referring now to FIG. 9, which is a flowchart of a method of generating a context-aware output of figures in accordance with an illustrative embodiment. The method comprises receiving one or more figures as an input information material, at block 902. These figures may include, but are not limited to, block diagrams, system architecture schematics, process flowcharts, graphs, or annotated illustrations. For example, the user may upload, as part of the input information material, a schematic diagram illustrating the operation of a smart irrigation system. The diagram may includes labeled components such as “Soil Sensor,” “Control Unit,” and “Valve Controller,” along with directional arrows indicating signal flow.

The method further includes detecting and extracting graphical and textual elements from the one or more figures, at block 904. For instance, the draft generation application 304, using the computer vision module 802 and the OCR module 804, breaks down the uploaded figure into its constituent components which includes detecting and extracting both graphical and textual elements form the figures. Graphical elements may include shapes such as rectangles, ellipses, arrows, lines, and connectors that represent components and their interactions. Textual elements may include component labels, operation steps, annotations, or callouts, and are extracted using optical character recognition (OCR) and deep learning-based text detection. With reference to the above example, in the uploaded irrigation system figure, the draft generation application 304 identifies three rectangular boxes labeled “Soil Sensor,” “Control Unit,” and “Valve Controller.” It also detects arrows pointing from the sensor to the controller and from the controller to the valve, indicating data and control flow. These spatial and semantic cues are stored in a structured format for further processing.

The method further comprises generating, using the LLM, context-aware output of the one or more figures based on the input information material in the context aware manner, at block 906. The draft generation system 302 employes the large language model (LLM) such as a transformer-based neural network, to generate descriptive textual content based on the extracted elements and their relationships. The generation is performed in a context-aware manner, meaning that the output considers the hierarchical, functional, and spatial relationships among the components within the figure, as well as other content present in the draft (such as the background, summary, or claim language). In some embodiments, the LLM may use predefined templates, semantic rules, and machine-learned representations to formulate natural language sentences that accurately describe what the figure illustrates. With continues reference to the above example, based on the previous extraction, the LLM may generate the description “FIG. X illustrates a smart irrigation system. The system comprises a Soil Sensor configured to detect soil moisture levels and transmit signals to a Control Unit. The Control Unit processes the signals and actuates a Valve Controller to regulate water supply to the soil . . . ”

Further, the use of context-awareness ensures that if a similar system was already mentioned in the background or summary section, the description will avoid redundancy and instead complement the existing content.

Finally, the method may optionally comprise analyzing the context of the generated context-aware output with respect to the other sections, at block 908. The draft generation application 304 analyzed the generated output of specification by comparing with other generated sections to ensure alignment of terminology, phrasing, and narrative flow. This context analysis may involve examining the claims, detailed description, abstract, or even prior figure descriptions to confirm that the generated content does not introduce inconsistencies. Additionally, the generated section is further analyzed to compare the context explained in it with the context of the input information material to ensure that the generated section does not deflect from original context. For example, If the claims refer to the “Control Unit” as a “processing module,” the system may adjust the figure description accordingly to say “ . . . a processing module configured to receive inputs from a moisture sensor and control valve operation . . . ”. In some embodiments, the draft generation application 304 may provide user review to enable revisioning before final insertion of the amendment in the final draft. In some embodiments, the draft generation application 304 may alternatively produce figures based on input descriptions for generating the figures, the input descriptions being obtained from one or more sections, portions, instructions, or prompts associated with the draft to be generated.

Reference is now made to FIG. 10 which illustrates architecture of a draft generation system 302 in accordance with one or more embodiments. According to the present embodiment, the draft generation application 304 may further comprise or be operatively coupled with multiple modules, other than the ones disclosed in the FIG. 3 and FIG. 8. For instance, the draft generation application 304 may comprise a summary generator 1002 and re-generation module 1004.

Similar to the context aware evaluator 310 and a generator 312, the summary generator 1002 and the re-generation module 1004 may also function either as software-based components (e.g., implemented through algorithms and machine learning models executed on a computing platform) or hardware-based elements (e.g., application-specific integrated circuits (ASICs), field-programmable gate arrays (FPGAs), or a combination thereof).

The summary generator 1002 is configured to generate a contextual summary of one or more input information materials. The input information material may include, for example, uploaded figures, prior art references, invention disclosure forms, claim sets, or partial draft sections. The summary generator 1002 utilizes contextual clues, such as defined terms, structure of the draft, or the surrounding textual content, to produce a condensed and coherent summary that highlights key features of the input. This summary serves as a foundational input to aid the draft generation process or to provide a high-level overview to the user.

For instance, upon receiving an invention disclosure form describing a multi-layer security protocol, the summary generator may output a paragraph summarizing the technical field, the unique approach taken by the invention, and the problem it addresses. This summary can be automatically inserted into the “Summary of the Invention” section or used to update the abstract portion of a patent draft. In some embodiments, the summary generator 1002 may also support summarization of multiple figures at once (e.g., summarizing FIGS. 1-3 collectively by recognizing common components, such as a shared system architecture or flow of operations).

Once the initial draft is generated by the generator 312, the re-generation module 1004 allows for interactive and context-aware modification of selected draft sections. Specifically, the draft generation application 304 provides a user interface with an ability of selection of the one or more sections in the generated draft. Further, it provides the ability to manually amend the section or associate a specific context aware instruction with the selected section. The re-generation module 1004 is configured to receive a selection of one or more sections of the draft (such as a paragraph, figure description, claim, or abstract), along with a context-aware instruction to regenerate or revise that section. The instruction may be user-provided, such as “rewrite in simpler terms,” “add reference to claim 3,” or “modify based on updated figure labeling”, or it may be automatically suggested based on inconsistencies or improvements identified by the context aware evaluator 310.

The re-generation module 1004 may employ a localized generation strategy, meaning that it regenerates only the selected portion while taking into account the surrounding draft context. For example, if a user selects a portion of the description that refers to a “network hub” and provides an instruction to change it to “data node” to align with the updated claims, the re-generation module not only substitutes the term but adjusts the surrounding language to maintain technical accuracy and grammatical clarity.

In some implementations, the re-generation module 1004 supports bulk or batched regeneration, allowing the user to apply the same regeneration instruction across multiple sections (e.g., “update all occurrences of ‘AI module’ to ‘machine learning engine’ across the draft.”). Moreover, version history of regenerated content may be stored and made available for rollback or audit purposes, ensuring transparency and traceability during iterative drafting processes. Accordingly, the summary generator 1002 and the re-generation module 1004 enhance the flexibility, clarity, and efficiency of the draft generation system 302 by enabling both high-level synthesis and detailed, section-specific refinements.

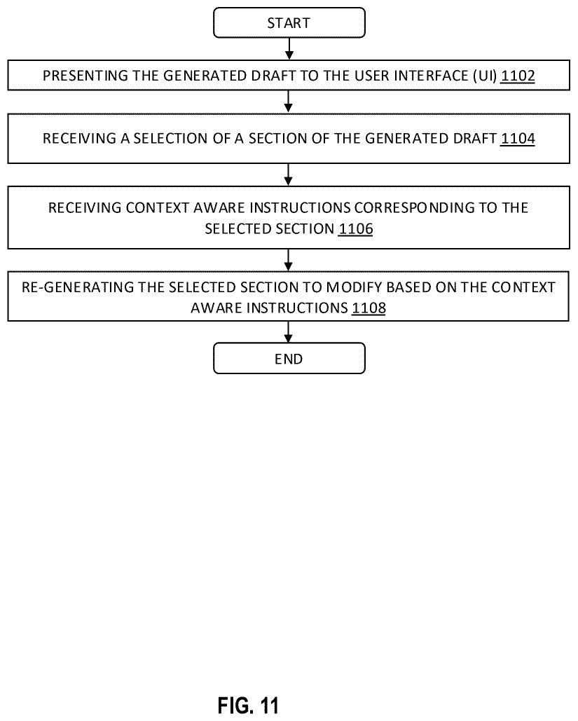

FIG. 11 is a flowchart of a method of re-generating the draft in accordance with an illustrative embodiment. Referring to FIG. 11, the method includes presenting the generated draft to the user interface (UI), at block 1102. For example, the draft generation application 304 presents the generated draft to the user.

The method further comprises receiving a selection of a section of the generated draft, at block 1104. For example, the draft generation application 304 may enable to user to select the desired section of the generated draft, in case of requirement of refinement or regeneration in specific manner. Further, the UI presented by the draft generation application 304 enables user to manually modify content in any section or assign a prompt (context-aware instruction) for the re-generator 1004.

The method further comprises receiving context aware instructions corresponding to the selected section, at block 1106.

Successively, the method comprises re-generating the selected section to modify based on the context aware instructions, at block 1108. For example, the re-generation module 1004 regenerates the selected draft section in accordance with the instructions, utilizing the same or a refined context derived from the entire document.

This allows modular, intelligent drafting workflows, where draft sections are dynamically generated, reviewed, and refined using contextual awareness, large language models, and user-directed feedback loops.

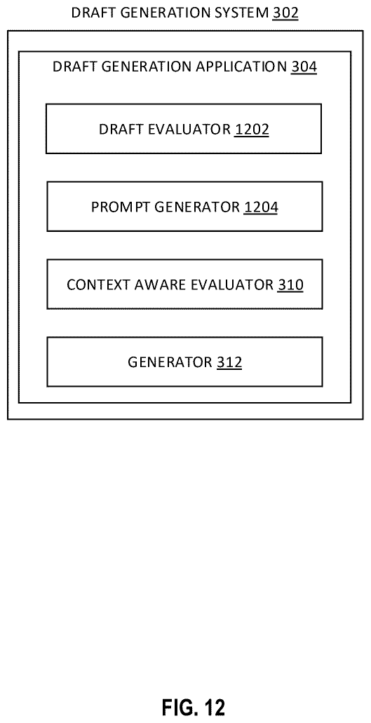

Referring now to FIG. 12, which illustrates architecture of a draft generation system 302 in accordance with an embodiment of present disclosure. In some embodiments, the draft generation application 304 may automatically generate the prompts to adapt to the style of existing document of the user. For instance, the draft generation application 304 may analyze the existing document to generate prompts for creation of output in similar style which when evaluated, may generate the context-aware output in the style similar to the existing document. The draft generation application 304 may comprise or be operatively coupled with a draft evaluator 1202, a prompt generator 1204, a context-aware evaluator 310, and a generator 312, which may be employed to generate the automated personalised output draft for the input information material.

The draft evaluator 1202 may be configured to receive a reference draft associated with a user. The reference draft may correspond to a previously authored or published document such as a patent application or technical specification. Upon receiving the reference draft, the draft evaluator 1202 is operable to analyze and classify portions of the draft into two categories: (i) static text, and (ii) dynamic text. The static text refers to boilerplate sections such as standard background language, template claims, or legal disclaimers that generally remain unchanged across filings. In contrast, the dynamic text includes user-specific content, for example, claims, detailed descriptions, or problem-solution statements, which are typically customized for each new invention.

The classification may be performed using trained machine learning models, heuristics, or pattern recognition techniques. For instance, the system may compare sections across multiple prior drafts to detect common phrases indicative of boilerplate content, while distinguishing novel or invention-specific language. Optionally, the evaluator 1202 may tag each section with metadata indicating its type (e.g., “background,” “summary,” “embodiment,” “claim”) or role (e.g., “fixed,” “replaceable,” “requires prompt”), allowing downstream modules to operate on section-specific logic.

The dynamic portions identified are portions that require contextual regeneration. For these portions, the draft generation system 302 aims to produce updated content that reflects new input information material, such as invention disclosures, technical data, or notes provided by the user.

The prompt generator 1204 is configured to generate one or more natural language prompts based on each dynamic portion of the reference draft. Each prompt serves as an instruction or contextual wrapper to guide the language model (LLM) to generate new content that reflects the input information material. The prompts may be auto-constructed using templates learned from previous drafts, manually defined rules, or model-based transformations.

The generated prompts preserve the linguistic and structural style of the reference draft to ensure stylistic consistency. For example, if the original section begins with “In accordance with one embodiment . . . ,” the corresponding prompt may be: “Describe the embodiment of the invention using the following details while preserving the above writing style.”

In some embodiments, the draft generation system may utilize a prompt construction library, which maps reference draft structures to prompt templates, or employs an instruction-tuning model that fine-tunes prompts based on a repository of real-world drafting examples.

Further, the context-aware evaluator 310 is configured to receive the generated new prompts along with the user's input information material. The input information may include plain text, structured fields, claim charts, invention disclosure forms, or other semantically meaningful data. The context-aware evaluator 310 assesses whether the prompts are sufficient to yield contextually aligned outputs. The context-aware evaluator 310 may be implemented using an LLM.

Further, the generator 312 may be implemented using a transformer based LLM, processes the finalized prompts together with the input information material and generates context-aware text output. The output is designed to stylistically emulate the reference draft while semantically capturing the new content. This ensures the regenerated draft aligns with both the original drafting style and the updated technical subject matter.

The generated output is inserted into the respective section of a regenerated draft, replacing the dynamic portion while retaining the static portions untouched. For example, if a section in the reference draft described the benefits of an AI system, the new output would describe similar benefits for a different AI invention using consistent linguistic framing.

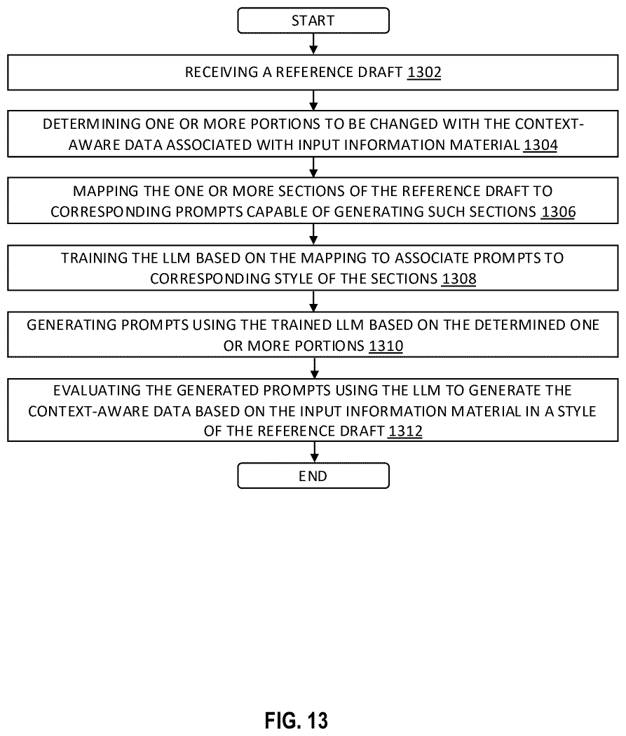

FIG. 13 is a flowchart of a method of generating prompt in accordance with an illustrative embodiment. Referring to FIG. 13, the method comprises receiving a reference draft, at block 1302. For example, the draft generation application 304 may receive a reference draft, which serves as a stylistic and structural blueprint for generating a new draft. The reference draft may be any previously authored document, such as a technical specification, invention disclosure, published patent application, legal agreement, or regulatory filing. For example,

The method further comprises determining one or more portions to be changed with the context-aware data associated with input information material, at block 1304. The draft generation application 304 analyzes the reference draft to determine which parts should be regenerated using new input information material. These parts are referred to as dynamic sections, and the remainder are considered static and retained.

Further, the method comprises mapping the one or more sections of the reference draft to corresponding prompts capable of generating such sections, at block 1306. For example, the draft generation application 304 maps each identified dynamic section of the reference draft to a corresponding natural language prompt that can guide the LLM to regenerate that section. This mapping captures both functional purpose and linguistic style.

Further, the method comprises training the LLM based on the mapping to associate prompts to the corresponding style of the sections, at block 1308. For instance, the draft generation system 302 may train the LLM to associate prompt structures with the corresponding styles observed in the reference draft. This enables the model to internalize the connection between prompt formats and their resulting output styles.

Further, the method comprises generating prompts using the trained LLM based on the determined one or more portions, at block 1310. The draft generation application 304 uses the trained LLM and the results of the earlier blocks to automatically generate optimized prompts for each dynamic portions of the reference draft.

Successively, the method comprises evaluating the generated prompts using the LLM to generate the context-aware data based on the input information material in a style of the reference draft, at block 1312. For example, the prompts are used in conjunction with the input information material to generate the regenerated draft content, which reflects the new subject matter while preserving the original style. The draft generation application 304 may also evaluate the quality of the generated output using semantic similarity, format checks, or feedback scoring. If necessary, prompts are revised, and the generation is repeated.

In some cases, the draft generation system 302 may go beyond what is provided in the user-submitted input information material, while keeping the context relevant. In this manner, the LLM can include helpful background information or explain related ideas that make the content clearer or more complete. For example, if a user gives basic information about a new type of engine, the system might add a short history of engine development or mention common problems with older engines to better explain why the new invention matters, even though that extra detail wasn't in the original input.

### CONCLUSION

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments.

For example one or more combinations of the following examples are possible:
1. A computer-implemented method comprising: receiving custom template material comprising static text and prompts; evaluating the prompts using a trained large language model (LLM) to generate a context-aware output for each prompt based on input information material; and generating a technical draft based on the custom template material by preserving the static text and replacing the prompts with the generated context-aware output in a context-aware manner, wherein the context-aware manner takes into consideration at least a context of surrounding static text.
2. The computer-implemented method of example 1, further comprising: providing at least one of an invention disclosure document, a transcript, or a set of examples as part of the input information material.
3. The computer-implemented method any of the preceding examples, wherein the input information material is in a form of at least one of a document, a stored text object, an input live text, an input audio, or input video.
4. The computer-implemented method of any of the preceding examples, further comprising: receiving context-aware instructions corresponding to different sections of the technical draft, wherein the context-aware instructions determine a manner in which the prompts are to be evaluated; and evaluating the prompts, based on the section to which the prompts belong, to generate the context-aware output corresponding to the section.
5. The computer-implemented method of any of the preceding examples, further comprising: assigning relevance scores to one or more input information materials; and generating the technical draft based on a consideration of a relevance score of the one or more input information materials, wherein input information from an input information material with a higher relevancy score is prioritized in generating the technical draft.
6. The computer-implemented method of any of the preceding examples, further comprising: receiving the static text and the prompts input through a user interface; generating a custom input template material based on the received static text and the prompts.
7. The computer-implemented method of any of the preceding examples, further comprising: providing one or more figures as an input information material; generating, using the LLM, context-aware output of the one or more figures based on the input information material, wherein the generated context-aware output of the one or more figures is a description of the one or more figures.
8. The computer-implemented method of any of the preceding examples, wherein the generation of the description further comprises: detecting and extracting graphical and textual elements from the one or more figures; determining a semantic relationship between the extracted elements; and generate the context-aware output based on the determined semantic relationship.
9. The computer-implemented method of any of the preceding examples, further comprising: receiving a video as part of the input information material; generating, using the LLM, a transcript or interpretation; and evaluating the prompts, using the LLM, to generate the context-aware output based on the generated transcript or interpretation and input information material.
10. The computer-implemented method of any of the preceding examples, further comprising: differentiating, in the technical draft, the generated context-aware output from the static text by color-coding the static text.
11. The computer-implemented method of any of the preceding examples, further comprising: receiving a selection of a section of the generated technical draft; receiving context aware instructions corresponding to the selected section; and re-generating the selected section in the context aware manner.
12. The computer-implemented method of any of the preceding examples, wherein the evaluation of the prompts further comprises: evaluating, using a plurality of LLMs in a cascade manner, to generate the context-aware output.
13. The computer-implemented method of any of the preceding examples, wherein the prompts are standard prompts that include predetermined instructions or custom prompts that include at least natural language user instructions, wherein the prompts are discriminated based on predetermined prompt identifiers.
14. The computer-implemented method of any of the preceding examples, wherein the custom prompts are based on standard prompts.
15. The computer-implemented method of any of the preceding examples, wherein the standard prompts are fixed terminology that correspond to predetermined instructions for execution by the LLM using information contained in a set of input information material.
16. The computer-implemented method of any of the preceding examples, wherein the one or more prompts are provided in a live manner.
17. The computer-implemented method of any of the preceding examples, wherein the one or more prompts are provided in a non-live manner.
18. A computer program product comprising: one or more computer-readable storage devices and program instructions stored on the at least one of the one or more computer-readable storage devices, the program instructions executable by a processor, the program instructions comprising: programs instructions to receive custom template material comprising static text and prompts; programs instructions to evaluate the prompts using a trained large language model (LLM) to generate a context-aware output for each prompt based on input information material; and programs instructions to generate a technical draft based on the custom template material by preserving the static text and replacing the prompts with the generated context-aware output in a context-aware manner, wherein the context-aware manner takes into consideration at least a context of surrounding static text.
19. A computer-implemented method comprising: receiving a reference technical draft associated with a user; determining one or more portions of the reference technical draft not meeting a predetermined static text criterion; wherein the one or more portions correspond to information that changes for different technical drafts; generating prompts, using an LLM, for the one or more portions to generate a template comprising static text and prompts; and evaluating the generated prompts using another LLM and new input information material to generate a context-aware output for a new technical draft in a style of the reference technical draft.
20. The computer-implemented method of example 19, further comprising; extracting one or more other styles from the reference technical data, and using the extracted one or more other styles to generate the context-aware output for a new technical draft.

The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method comprising:
receiving custom template material comprising static text and prompts;
evaluating the prompts using a trained large language model (LLM) to generate a context-aware output for each prompt based on input information material; and
generating a technical draft based on the custom template material by preserving the static text and replacing the prompts with the generated context-aware output in a context-aware manner, wherein the context-aware manner takes into consideration at least a context of surrounding static text.

2. The computer-implemented method of claim 1, further comprising:
providing at least one of an invention disclosure document, a transcript, or a set of claims as part of the input information material.

3. The computer-implemented method of claim 2, wherein the input information material is in a form of at least one of a document, a stored text object, an input live text, an input audio, or input video.

4. The computer-implemented method of claim 1, further comprising:
receiving context-aware instructions corresponding to different sections of the technical draft, wherein
the context-aware instructions determine a manner in which the prompts are to be evaluated; and
evaluating the prompts, based on the section to which the prompts belong, to generate the context-aware output corresponding to the section.

5. The computer-implemented method of claim 1, further comprising:
assigning relevance scores to one or more input information materials; and
generating the technical draft based on a consideration of a relevance score of the one or more input information materials, wherein
input information from an input information material with a higher relevancy score is prioritized in generating the technical draft.

6. The computer-implemented method of claim 1, further comprising:
receiving the static text and the prompts input through a user interface;
generating a custom input template material based on the received static text and the prompts.

7. The computer-implemented method of claim 1, further comprising:
providing one or more figures as an input information material;
generating, using the LLM, context-aware output of the one or more figures based on the input information material,
wherein the generated context-aware output of the one or more figures is a description of the one or more figures.

8. The computer-implemented method of claim 7, wherein the generation of the description further comprises:
detecting and extracting graphical and textual elements from the one or more figures;
determining a semantic relationship between the extracted elements; and
generate the context-aware output based on the determined semantic relationship.

9. The computer-implemented method of claim 1, further comprising:
receiving a video as part of the input information material;
generating, using the LLM, a transcript or interpretation; and
evaluating the prompts, using the LLM, to generate the context-aware output based on the generated transcript or interpretation and input information material.

10. The computer-implemented method of claim 1, further comprising:
differentiating, in the technical draft, the generated context-aware output from the static text by color-coding the static text.

11. The computer-implemented method of claim 1, further comprising:
receiving a selection of a section of the generated technical draft;
receiving context aware instructions corresponding to the selected section; and
re-generating the selected section in the context aware manner.

12. The computer-implemented method of claim 1, wherein
the evaluation of the prompts further comprises:
evaluating, using a plurality of LLMs in a cascade manner, to generate the context-aware output.

13. The computer-implemented method of claim 1, wherein the prompts are standard prompts that include predetermined instructions or custom prompts that include at least natural language user instructions, wherein the prompts are discriminated based on predetermined prompt identifiers.

14. The computer-implemented method of claim 13, wherein the custom prompts are based on standard prompts.

15. The computer-implemented method of claim 13, wherein the standard prompts are fixed terminology that correspond to predetermined instructions for execution by the LLM using information contained in a set of input information material.

16. The computer-implemented method of claim 1, wherein the one or more prompts are provided in a live manner.

17. The computer-implemented method of claim 1, wherein the one or more prompts are provided in a non-live manner.

18. A computer program product comprising:
one or more computer-readable storage devices and program instructions stored on the at least one of the one or more computer-readable storage devices, the program instructions executable by a processor, the program instructions comprising:
programs instructions to receive custom template material comprising static text and prompts;
programs instructions to evaluate the prompts using a trained large language model (LLM) to generate a context-aware output for each prompt based on input information material; and programs instructions to generate a technical draft based on the custom template material by preserving the static text and replacing the prompts with the generated context-aware output in a context-aware manner, wherein the context-aware manner takes into consideration at least a context of surrounding static text.

19. A computer-implemented method comprising:
receiving a reference technical draft associated with a user;
determining one or more portions of the reference technical draft not meeting a predetermined static text criterion; wherein the one or more portions correspond to information that changes for different technical drafts;
generating prompts, using an LLM, for the one or more portions to generate a template comprising static text and prompts; and
evaluating the generated prompts using another LLM and new input information material to generate a context-aware output for a new technical draft in a style of the reference technical draft.

20. The computer-implemented method of claim 19, further comprising;
extracting one or more other styles from the reference technical data, and
using the extracted one or more other styles to generate the context-aware output for a new technical draft.
